(19) United States
(12) Patent Application Publication
(10) Pub. No.: US 2015/0039146 A1
(43) Pub. Date: Feb. 5, 2015

(54) POWER LOAD MONITORING AND PREDICTING SYSTEM AND METHOD THEREOF

(71) Applicant: Yuan Ze University, Taoyuan County (TW)

(72) Inventors: JUNG-TZUNG WEI, TAOYUAN COUNTY (TW); YU-CHIH HUANG, TAOYUAN COUNTY (TW)

(73) Assignee: Yuan Ze University, Taoyuan County (TW)

(21) Appl. No.: 14/082,409

(22) Filed: Nov. 18, 2013

(30) Foreign Application Priority Data
Aug. 2, 2013 (TW) 102127772

(51) Int. Cl. G05B 13/02

(52) U.S. Cl. CPC G05B 13/026
USPC 700/291

(57) ABSTRACT

A power load monitoring and predicting system coupling to a plurality of load devices is offered. The system includes a control unit, a measuring unit, and a loading/unloading unit. The measuring unit, and the loading/unloading are coupled to the control unit. The measuring unit measures an actual demand of the plurality of the load devices during a time period. The control unit calculates a predicted demand during a second time period according to the actual demand in a first time period. The loading/unloading unit unloads at least one of the load devices when the determined predicted demand during the second time period is larger than a threshold, in order to make the actual demand in the second time period be less than a predetermined demand target.

### BACKGROUND OF THE INVENTION

1. Field of the Invention

The instant disclosure relates to a load monitoring and predicting system and method thereof; in particular, to a power load monitoring and predicting system and a method thereof.

2. Description of Related Art

In general, the electricity is not easy to be stored, and the power company needs to provide electricity to customers according to the corresponding contracted capacities in order to maintain the stability of power delivery. However, the temperature goes up in summer, thus the power consuming of air conditioning would be greatly increased for cooling air. The temperature goes down in winter, thus the power consuming of air conditioning or heater would also be greatly increased for heating air. Accordingly, the power company needs to turn on extra power generators to meet the increased demand of electrical power. In other words, the reserve margin of the power company should be increased, and the power company would charge the customers for penalty when customers consume power exceeding the contracted capacities, in which the penalty may be twice (or triple) of the basic tariff.

Specifically, the power company may take the demand measured by 15 minutes average as the actual demand, and the “maximum demand” may be the maximum in the 2880 times of the actual demands. Therefore, the “maximum demand” is one of the safety indexes for the power control system of the power company. Especially, during the rush hour of power consuming, e.g., at noon of the summer, the power demands of customers easily exceed the contracted demands. Conventionally, the energy conservation action is directly turning off electronic equipment. However, in order to achieve energy saving, it is ignoring to the user's feeling when directly unloading or turning off the load devices.

### SUMMARY OF THE INVENTION

The object of the instant disclosure is to provide a power load monitoring and predicting system and a method thereof.

In order to achieve the aforementioned objects, according to an embodiment of the instant disclosure, a power load monitoring and predicting system is offered. The power load monitoring and predicting system is for monitoring power load of a plurality of load devices. The power load monitoring and predicting system comprises a measuring unit measuring the actual demand of the plurality of load devices during a base period. The power load monitoring and predicting system also comprises a control unit. The control unit coupled to the measuring unit calculates a predicted demand of the plurality of load devices during the second base period according to the actual demand of the plurality of load devices during the second base period. The control unit further determines whether the predicted demand of the plurality of load devices during the second base period is larger than a threshold. The power load monitoring and predicting system further comprises a loading/unloading unit. The loading/unloading unit coupled to the control unit unloads at least one of the load devices when the predicted demand of the plurality of load devices during the second base period is larger than the threshold, so as to make the actual demand of the plurality of load devices during the second base period be less than a predetermined demand target, wherein the threshold is determined by the control unit according to a proportion of the demand target.

In order to achieve the aforementioned objects, according to an embodiment of the instant disclosure, a power load monitoring and predicting method is offered. The power load monitoring and predicting method is for monitoring power load of a plurality of load devices. The power load monitoring and predicting method comprising: measuring a first actual demand of the plurality of load devices during a first base period by a measuring unit; calculating a first predicted demand of the plurality of load devices during a second base period by a control unit; and unloading at least one of the plurality of load devices by a loading/unloading unit when the control unit determines that the first predicted demand is larger than a threshold, so as to make a second actual demand of the plurality of load devices be less than a predetermined demand target during the second base period, wherein the threshold is determined according to a proportion of the demand target.

The embodiments of the instant disclosure provide a power load monitoring and predicting system and a method thereof for the energy saving topic. The energy saving method is implemented in compliance with comfortable environment while maintaining the actual demand less than the demand target.

In order to further the understanding regarding the instant disclosure, the following embodiments are provided along with illustrations to facilitate the disclosure of the instant disclosure.

### BRIEF DESCRIPTION OF THE DRAWINGS

FIG. 1A shows a schematic diagram of a plurality of fields according to an embodiment of the instant disclosure;

FIG. 1B shows a schematic diagram of a single filed according to an embodiment of the instant disclosure;

FIG. 2 shows a block diagram of a power load monitoring and predicting system according to an embodiment of the instant disclosure;

FIG. 3-1 and FIG. 3-2 show a table of the environmental parameters corresponding to the load device according to an embodiment of the instant disclosure;

FIG. 4 shows a curve diagram of the control result of a power load monitoring and predicting method according to an embodiment of the instant disclosure;

FIG. 5 shows a schematic diagram of a display interface of a display unit of a power load monitoring and predicting system according to an embodiment of the instant disclosure; and

FIG. 6 shows a flow chart of a power load monitoring and predicting method according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

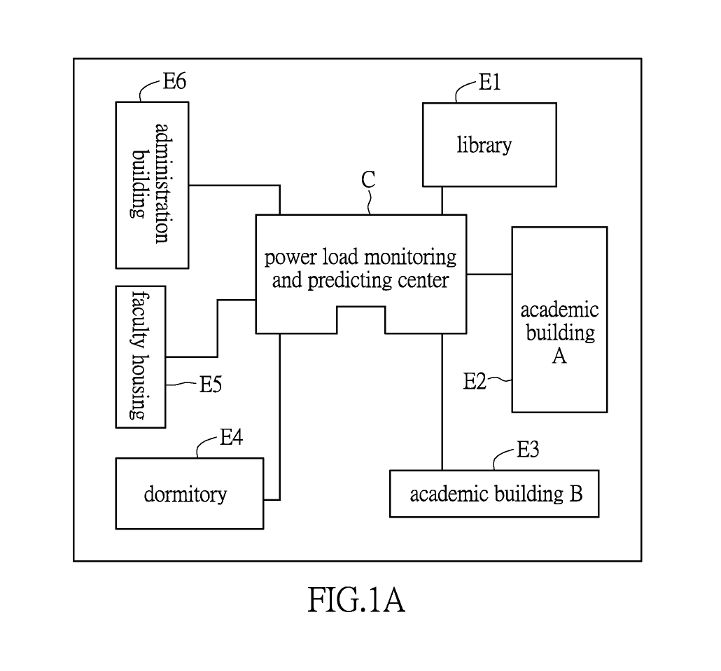

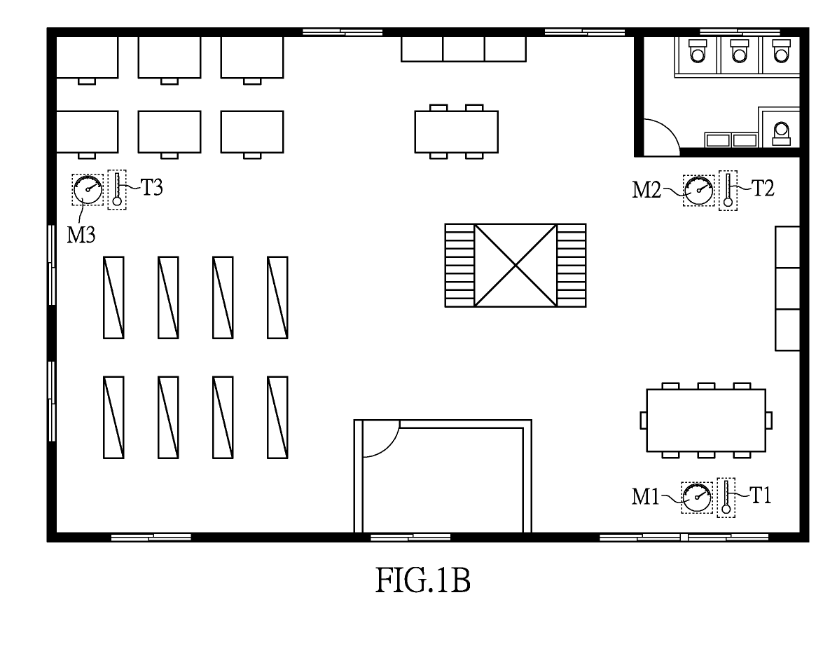

FIG. 1A shows a schematic diagram of a plurality of fields according to an embodiment of the instant disclosure. The field E1, E2, E3, E4, E5, and E6 are respectively a library, an academic building A, an academic building B, a dormitory, a faculty housing and an administration building which are installed with central air conditioning systems, for example. The power load monitoring and predicting center C is connected to the central air conditioning systems of the fields E1, E2, E3, E4, E5, and E6 for monitoring and predicting the power consumption for the electronic equipment of the air conditioning systems. For example, the power load monitoring and predicting center C measures the power consumption of each field, and predicts the future power demand of each field according to the historical information of the power consumption. For example, the power load monitoring and predicting center C measures and predicts power demand every fifteen minutes. The power load monitoring and predicting center C predicts the possible power demand of each field in the next fifteen minutes according the historical information of power demand in every fifteen minutes. The prediction method could be achieved by a smart estimation scheme formed of the neural network, the fuzzy neural network, the genetic algorithm, the particle swarm optimization algorithm, or a combination thereof. Therefore, the power load monitoring and predicting center C could load a part of the electronic equipment in these fields according to the predicted power demand.

The power load monitoring and predicting system disclosed in the instant disclosure gives considerations for comfortable environment. FIG. 1B shows a schematic diagram of a single filed according to an embodiment of the instant disclosure. In FIG. 1B, the library of the field E1 is taken an example. The library comprises a basement B1, a first floor 1F and a second floor 2F. For consideration of the environmental status such as the temperature and the humidity, each of the three positions on each floor is set up with a thermometer T1 (T2 or T3) and a hygrometer M1 (M2 or M3), as shown in FIG. 1B. Because the basement B1 would not affected by sunlight, the average of measured temperatures in each measuring position of the basement B1 is lower than the measured temperatures in the measuring positions on other floors. Additionally, the thermometers T1 and T3 on the second floor 2F are both near to the windows which are often lighted by sunlight, thus the averages of measured temperatures in these two positions are both higher than the average of measured temperature of the thermometer T2. In other words, when the power load monitoring and predicting center C determines that the power demand of each field needs to be adjusted, the power load monitoring and predicting center C determines which electronic equipment should be unload according to the environmental status of each measuring position on each floor.

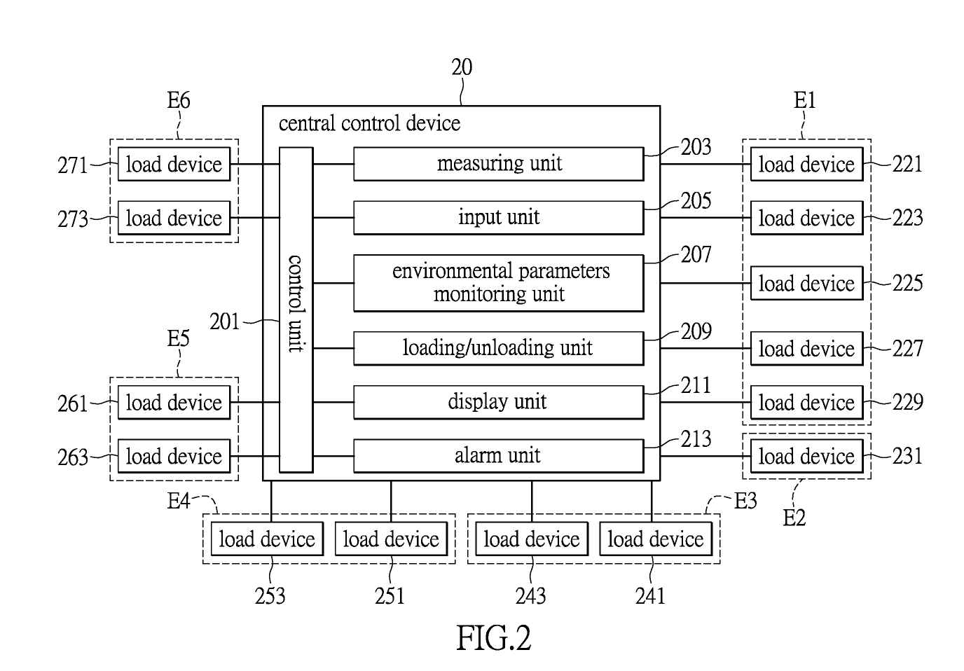

FIG. 2 shows a block diagram of a power load monitoring and predicting system according to an embodiment of the instant disclosure. Please refer to FIG. 1 in conjunction with FIG. 2, the power load monitoring and predicting system 20 is installed in the power load monitoring and predicting center C for monitoring the power loads of the monitored fields E1-E6. The power load monitoring and predicting system 20 comprises a control unit 201, a measuring unit 203, an input unit 205, an environmental parameters control unit 207, a loading/unloading unit 209, a display unit 211 and an alarm unit 213. The measuring unit 203 is coupled to the control unit 201. The measuring unit 203 measures the actual demand of the plurality of load devices during a base period. For example, the measuring unit 203 measures the power consumption of all load devices of the central air conditioning in real time, and the measuring unit 203 re-accumulate the effective average power demand in each period of time (e.g., each 15 minutes), and the effective average power demand may be 3619 kW, for example. The measuring unit 203 is the electricity meter, the multimeter, the power analyzer, or the current clamp.

According to the actual demand of the plurality of load devices during a base period, the control unit 201 calculates a predicted demand of the plurality of load devices during the next base period. In this embodiment, the control unit 201 utilizes the fuzzy neural network or the particle swarm optimization algorithm to estimate the predicted demand of all load devices during next 15 minutes according to the actual demand. Details of the calculation made by the control unit 201 utilizing the fuzzy neural network are described in the following.

The fuzzy neural network is composed of an input layer, a membership layer, a rule layer and an output layer. These four layers of the network could be described in the following equations.

For the first layer (input layer), the net input and the net output of the i-th neuron respectively are

netᵢ¹=xᵢ¹,yᵢ¹=fᵢ¹(netᵢ¹)=netᵢ¹ (equation 1),

wherein xᵢ¹ is the input signal of the i-th neuron.

For the second layer (membership layer), each neuron of this layer represents the corresponding characteristic of the membership layer. In this embodiment, the Gaussian function is for describing the corresponding membership. Thus, the net input and the net output of the j-th neuron in this layer respectively are

$${net}_{j}^{2} = - \frac{{( {x}_{i}^{2} - {m}_{ij} )}^{2}}{{( {σ}_{ij} )}^{2}} , and$$

$${y}_{j}^{2} = {f}_{j}^{2} ( {net}_{j}^{2} ) = exp ( {net}_{j}^{2} ) , \qquad ( equation 2 )$$

wherein xᵢ² is the input of the i-th linguistic variables of the second layer, mᵢⱼ and σᵢⱼ respectively are the mean and the standard deviation of xᵢ² corresponding to the Gaussian function in the j-th neuron.

For the third layer (rule layer), the net input and the net output of the k-th neuron respectively are

$${net}_{k}^{3} = {Π}_{j} {w}_{jk}^{3} {x}_{j}^{3} , and {y}_{k}^{3} = {f}_{k}^{3} ( {net}_{k}^{3} ) = {net}_{k}^{3} , \qquad ( equation 3 )$$

wherein xⱼ³ is the input of the j-th neuron of the third layer, wⱼₖ³ is the connection between the membership layer and the rule layer.

For the fourth layer (output layer), the net input and the net output of the o-th neuron of the fourth layer respectively are

$${net}_{o}^{4} = {Σ}_{k} {w}_{ko}^{4} {x}_{k}^{4} , and {y}_{o}^{4} = {f}_{o}^{4} ( {net}_{o}^{4} ) = {net}_{o}^{4} , \qquad ( equation 4 )$$

wherein wₖₒ⁴ is the output strength related to the k-th rule, xₖ⁴ is the input of the k-th neuron of the fourth layer, yₒ⁴ is the output of the fuzzy neural network.

For training the efficiency of the fuzzy neural network, this embodiment applies an online learning algorithm to reduce the error. Specifically, the online learning algorithm is a back-propagation algorithm utilizes a gradient descent method to fast adjust the connected weighting, the center and the width of the fuzzy rule base. First, the energy function is defined as:

E=(x_{f}−xₗ)²/2=e²/2 (equation 5),

wherein x_{f} is the predicted demand, xₗ is the actual demand, e is the error between the predicted demand and the actual demand. The weighting of the fuzzy neural network, the center of the fuzzy rule base and the width of the Gaussian function are adjusted by equations as follows:

$$\begin{matrix}Δ {w}_{ko}^{4} = - {η}_{w} \frac{\partial E}{\partial {w}_{ko}^{4}} = {η}_{w} {δ}_{o}^{4} {x}_{k}^{4} , & ( equation 6 ) \\ Δ {m}_{ij} = {δ}_{j}^{2} \frac{2 ( {x}_{i}^{2} - {m}_{ij} )}{{( {σ}_{ij} )}^{2}} , and & ( equation 7 ) \\ {Δσ}_{ij} = {δ}_{j}^{2} \frac{2 {( {x}_{i}^{2} - {m}_{ij} )}^{2}}{{( {σ}_{ij} )}^{3}} , & ( equation 8 )\end{matrix}$$

wherein Δwₖₒ⁴, is the weighting variation of the output layer, Δmᵢⱼ is the center variation of the Gaussian function, Δσᵢⱼ is the width variation of the Gaussian function of the membership layer, η_{w} is the learning rate of the weighting of the fuzzy neural network, ηₘ and η_{σ} respectively are the learning rates of the center and width of the Gaussian function in the fuzzy neural network. It is worth mentioning that, the selection of the learning rate greatly affects the preference of the fuzzy neural network. Therefore, this embodiment utilizes the output error to adjust variations of the learning rates θ_{w}, ηₘ and η_{σ}. And, the discrete-type Lyapunov function has been proofed that the output error could be converged, in order to obtain the learning rates adapted to a specific network type. These learning rates are described as follows:

η_{w}=λ/(P_{wmax}²)=λ/Rᵤ (equation 9),

ηₘ=λ/(P_{wmax}²)=η_{w}[|wₖₒₘₐₓ⁴|(2/σᵢⱼₘᵢₙ)]⁻² (equation 10), and

η_{σ}=λ/(P_{σmax}²)=η_{w}[|wₖₒₘₐₓ⁴|(2/σᵢⱼₘᵢₙ)]⁻² (equation 11),

wherein λ is a positive constant.

Additionally, in another embodiment, a particle swarm optimization algorithm is utilized to estimate the predicted demand of all load devices. The initial state of the particle swarm optimization algorithm starts with a plurality of random particles, and the best solution is obtained through iterative calculating. In other words, the particle tracks two “extreme” to update own. The first extreme is the particle itself to find the optimal solution, that is, the individual extreme (pbest). For example, using a part of particles and taking the searched maximum of the particle in its neighborhood. Another extreme is a global extreme (gbest). Therefore, with these two extremes, the particle updates the velocity and position of the particle itself according to formula as follows:

V_{id}(t+1)=V_{id}(t)×w+c₁×rand(•)×[p_{pbest}(t)×_{id}(t)]+c₂×rand(•)×[p_{gbest}(t)−x_{id}(t)] (equation 12), and

x_{id}(t+1)=x_{id}(t)+V_{id}(t+1) (equation 13),

wherein x_{id} is the particle's position, V_{id} is the particle's velocity, t represents the number of iterations, p_{pbest} is the individual extreme value, P_{gbest} is the global extreme value, rand(•) is a random number between 0 and 1, w is inertia weight factor, c₁ and c₂ are positive accelerating parameters. Then, the particle swarm optimization algorithm is proceeded with steps as follows: [step 1] evaluating the fitness value of each particle; [step 2] memorizing the individual extreme (pbest) and comparing the fitness value and the individual extreme (pbest), and the particle memorizes and amends the particle's velocity for next search; [step 3] comparing the individual extreme (pbest) and the global extreme (gbest), if the individual extreme (pbest) is better than the global extreme (gbest) then amending the memory of the global extreme (gbest) and each particle amends the paritcle's velocity for next search according to the memorized global extreme (gbest); [step 4] randomly generating the updating velocity and position of each particle; [step 5] utilizing the equation 12 and the equation 13 to change the particle's velocity and position; [step 6] terminating the process when the termination condition is met, otherwise repeating step 2 to step 5.

The loading/unloading unit 209 is coupled to the control unit 201 for loading or unloading the plurality of load devices. The environmental parameters control unit 207 is coupled to the control unit 201, and each load device is corresponding to at least one environmental parameter. The environmental parameter may be the return water temperature of the central air conditioning, the room temperature, the room humidity or the concentration of carbon dioxide. The input unit 205 and the display unit 211 are coupled to the control unit 201. The display unit 211 displays the status of actual demand of the plurality of load devices for the system administrator of the power load monitoring and predicting center C. The alarm unit 213 is coupled to the control unit 201, for displaying an alarm signal or transmitting a short message to the system administrator when the power load of the system is abnormal. The system administrator could set the demand target or the difference value through the input unit 205 and the display unit 211. Details of the demand target and the difference value would be described hereinafter.

The control unit 201 calculates the predicted demand which means the possible power consumption of the plurality of load devices during next base period (e.g., from 4:15:00 pm to 4:29:59 pm) according to the actual demand of the plurality of load devices during the past base period (e.g., from 4:00:00 pm to 4:14:59 pm). Then, the control unit 201 determines whether the calculated predicted demand is larger than the threshold, wherein the threshold is determined according to a proportion of the demand target. For example, the threshold may be 1.05 times or 1.1 times of the demand target. The threshold can be determined arbitrarily according to demand of system design. In another embodiment, the method of utilizing the historical information for predicting the power demand of the future may comprise predicting the power demand of the month according to the actual demand of the last month, or predicting the power demand of August in this year according to the actual demand of August in last year.

In this embodiment, utilizing a predetermined demand target mode, the system administrator inputs the demand target (e.g., 3900 kW) through the input unit 205, and the display unit 211 displays the inputted demand target. The predetermined demand target mode of the power load monitoring and predicting system 20 controls the actual demand not to exceed 10% of the demand target. Thus, when the control unit 201 determines that the calculated predicted demand exceeds 10% of the predetermined demand target (e.g., 4290 kW), the alarm unit 213 sends alarm words shown in the display unit 211 or sends the alarm short message to the system administrator. Meanwhile, the control 201 would set the predicted demand to be the demand target, and the loading/unloading unit 209 would unload at least one (or more than two) of the plurality of load devices. Therefore, through unloading a part of the load devices by the loading/unloading unit 209, the actual demand of the plurality of load devices measured by the measuring unit 203 during next base period would be less than the predetermined demand target, in order to achieve unloading of the load devices.

In this embodiment, a smart estimation scheme formed of the fuzzy neural network or the particle swarm optimization algorithm calculates and predicts the power load during the next base period according to historical information of the power demand. The prediction method is simple, and the hardware costs of the hardware for collecting related information could be saved also.

In another embodiment, the power load monitoring and predicting system 20 comprises a demand setting mode. Specifically, the system administrator could preset the target of the power demand. The control unit 201 considers the first threshold (e.g., 1.1 times of the demand target) and a second threshold (e.g., 1.05 times of the demand target). During a base period, the measuring unit 203 continuously measures the power consumption of the load devices, and the control unit 201 calculates the predicted demand in real time. When the control unit 201 determines that the predicted demand of the load devices is larger than the second threshold but less than the first threshold, the loading/unloading unit 209 determines which load device (or load devices) should be unloaded according to the environmental parameter(s).

In this embodiment, the selected environmental parameter considered by the control unit 201 is the return water temperature of the central air conditioning. The environmental parameters monitoring unit 207 read the temperatures sensed by the thermometers of the cold water machine of the central air conditioning in the fields, in order to obtain the return water temperature of each central air conditioning. For example, the return water temperature of the cold water machine in the field E2 is 20° C., and the return water temperature of the cold water machine in the field E3 is 9° C., thus the control unit 201 gives a higher priority to unload the central air conditioning with lower return water temperature in the field E3. More specifically, the return water temperature of the cold water machine in the field E3 is lower than the return water temperature of the cold water machine in the field E2, which means the environment temperature of the field E3 is lower than the environment temperature of the field E2. Thus, considering the air conditions of these two fields, the user(s) in the field E2 with unloaded central air conditioning would feel more uncomfortable compared to the user(s) in the field E3 with unloaded air conditioning. In other words, a demand difference mode is provided by this embodiment which determines whether the user(s) would suffer uncomfortable environment according to the environmental parameters when the load device is unloaded, thus the user(s) would not feel uncomfortable due to unloading of the load device.

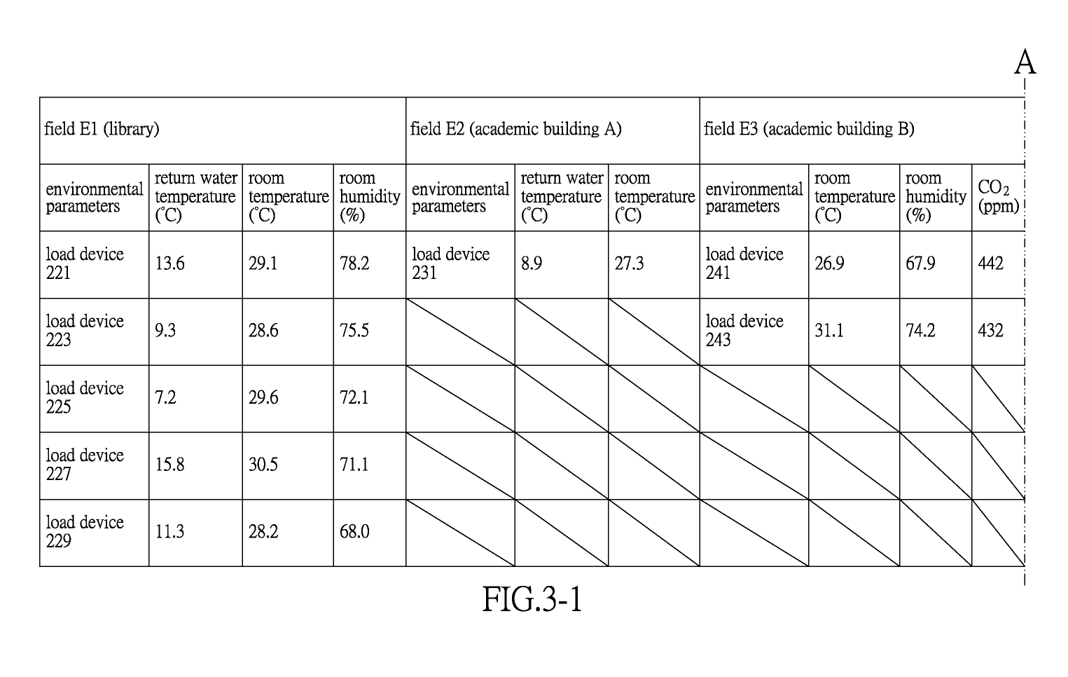

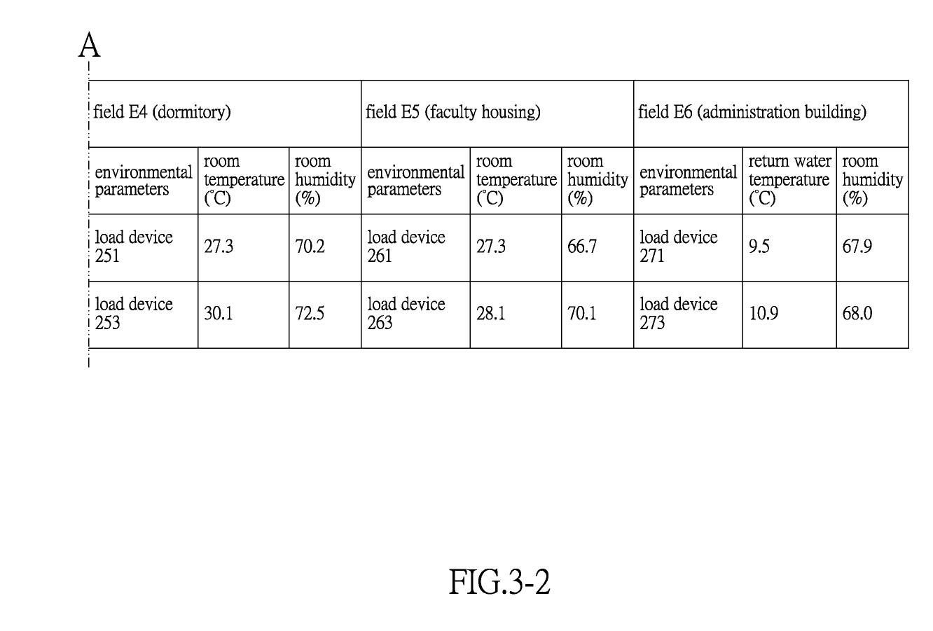

Furthermore, in this embodiment, the loading/unloading unit 209 unloads at least one (or more than two) of the plurality of load devices according to the environmental parameters, in order to unload a single load device or multiple load devices. FIG. 3-1 and FIG. 3-2 show a table of the environmental parameters corresponding to the load device according to an embodiment of the instant disclosure. In this embodiment, the field E1 is a library. The environmental parameters monitored by the environmental parameters monitoring unit 207 are return water temperature of the cold water machine of the central air conditioning, the room temperature and the room humidity. The control unit 201 monitors the overall loading status of all fields. When the control unit 201 determines to unload some load devices with considering the environmental parameters according to the status of the overall loading status, the environmental parameters monitoring unit 207 provides at least one environmental parameter to the control unit 201 for the judgment of the control unit 201, as shown in FIG. 3, for example. The environmental parameters monitoring unit 207 provides the return water temperature of the cold water machine of the central air conditioning to the control unit 201 for determining how to unload the load devices. Specifically, the control unit 201 sends an unload command to the loading/unloading unit 209, in which the unload command is for unloading the load device(s) with lower return water temperature. Then, the loading/unloading unit 209 unloads the commanded load device(s). Therefore, the actual demand measured by the measuring unit 203 during the next base period would be less than the predicted demand but larger the expected demand during the next base period, wherein the expected demand is the actual demand minus the preset difference value.

Additionally, in another embodiment, when the predicted demand is less than the second threshold (e.g., 1.05 times of the demand target), the loading/unloading unit 209 could reload at least one of the unloaded load devices according to environmental parameter(s).

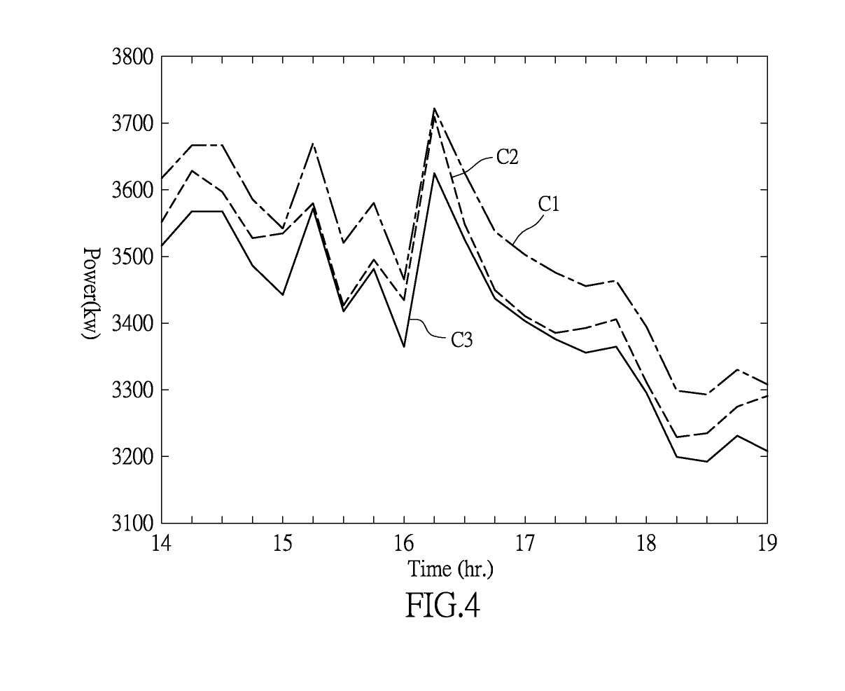

Please refer to FIG. 4 showing a curve diagram of the control result of a power load monitoring and predicting method according to an embodiment of the instant disclosure. The horizontal axis X is the time-axis, and the vertical axis Y represents the power demand in unit of kW. The curve C1 is the predicted demand, the curve C2 is the actual demand and the curve C3 is the expected demand. The expected demand is the actual demand minus the preset different value. Specifically, measuring unit 203 measures the actual demand of all load devices of the system in real time. The control unit 201 considers the measured actual demand as the historical information, and the control unit 201 calculates the predicted demand which is the curve C1 according to a smart estimation scheme formed of the fuzzy neural network or the particle swarm optimization algorithm. When the predicted demand exceeds the threshold, the control unit 201 would determine which load device(s) should be unload, then the actual demand measured by the measuring unit 203 would be the curve C2. By predicting the future power demand according to historical information and unloading the load device(s) in real time to adjust the actual demand of all load devices, the curve C2 representing the actual demand would be between the curve C1 and the curve C3.

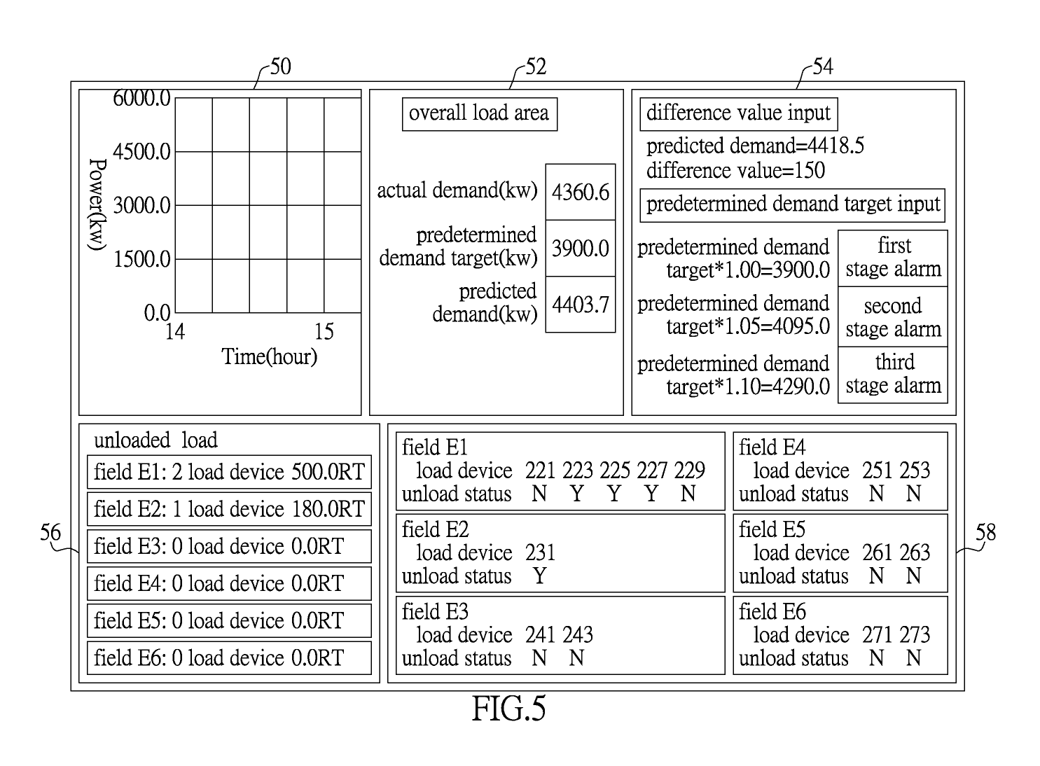

FIG. 5 shows a schematic diagram of a display interface of a display unit of a power load monitoring and predicting system according to an embodiment of the instant disclosure. A panel 50 shows the measured actual demand. A panel 52 displays the actual demand, demand target and the predicted demand of overall load area. A panel 54 provides a display interface showing the settings of difference value and the demand target, and the system administrator could input the difference value through the input interface 541 and input the demand target through the input interface 543. The panel 54 also displays the calculated thresholds and the corresponding alarms according to the demand target inputted by the system administrator. In FIG. 5, the threshold of the first stage alarm is 1.0 time of the demand target, the threshold of the second stage alarm is 1.05 times of the demand target, and the threshold of the third stage alarm is 1.1 times of the demand target.

Please refer to FIG. 3 in conjunction with FIG. 5, the panel 56 shows the power load after unloading through the loading/unloading unit 209 controlled by the control unit 201 according to the environmental parameter which is the return water temperature of the cold water machine of the central air conditioning. As shown in FIG. 5, the panel 56 shows two load units in the field E1 is unload, and one load unit in the field E2 is unload. Also, the panel 58 displays that the loading/unloading unit 209 has unloaded the load devices 223 and 225 in the field E1, and the load device 231 in the field E2.

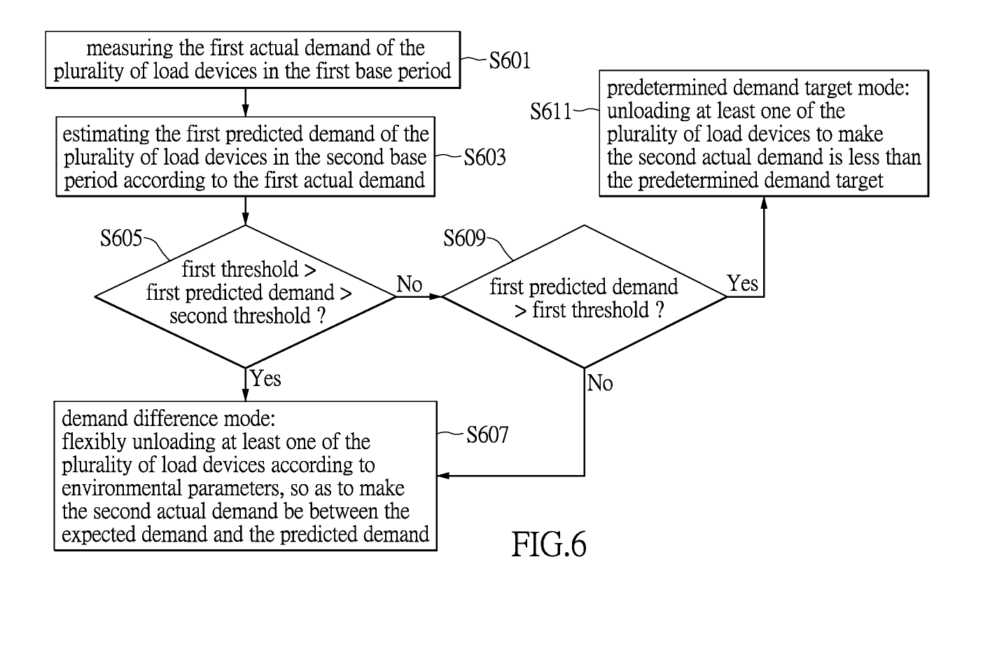

Please refer to FIG. 6 showing a flow chart of a power load monitoring and predicting method according to an embodiment of the instant disclosure. First, in step S601, the measuring unit measures the first actual demand of the plurality of load devices in the first base period. Then, in step S603, the control unit utilizes a smart estimation scheme formed of the neural network, the fuzzy neural network, the genetic algorithm, the particle swarm optimization algorithm, or a combination thereof to estimate the first predicted demand of the plurality of load devices in the second base period according to the first actual demand. Then, in step S605, the control unit determines whether the first predicted demand is less than the second threshold. When the first predicted demand is larger than the second threshold but less than the first threshold, executing step S607. In the step S607, entering to the demand difference mode, in which the loading/unloading unit flexibly unloads at least one of the plurality of load devices according to environmental parameters, so as to make the second actual demand be between the expected demand and the predicted demand (larger than the expected demand, and less than the predicted demand). When the first predicted demand is not between the first threshold and the second threshold in the step S605, executing step S609. In step S609, determining whether the first predicted demand is larger than the first threshold. When the first predicted demand is larger than the first threshold, entering to a predetermined demand target mode, step S611, in which the loading/unloading unit unloads at least one of the plurality of load devices to make the second actual demand be less than the predetermined demand target. Otherwise, when the first predicted demand is not larger than the first threshold in step S609, which means the first predicted demand is less than (or equal to) the second threshold, then returning to step S607 for executing the load difference mode.

According to above descriptions, the power load monitoring and predicting system and the method thereof could monitor a plurality of load device, and regard the measured actual demand as the historical information to calculate the predicted demand representing the possible power consumption of the plurality of load devices during next base period, so as to unload the load device(s) before the overall actual demand exceeds the demand target. As an example, preventing the actual demand to exceed the contracted capacity with the Taiwan power company. Thus, electricity usage could be reduced, and the penalty due to exceeding the contracted capacity could be also avoided, thus the controlling of energy saving is achieved. Additionally, the power load monitoring and predicting system and the method thereof consider environmental parameters for determining which load device(s) should be unload, and give a higher priority to unload the load device(s) of the environment whose environmental comfort does not change much after unloading the corresponding load device(s). Therefore, the controlling of energy saving and maintaining the environmental comfort could be achieved simultaneously.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A power load monitoring and predicting system, for monitoring power load of a plurality of load devices, the power load monitoring and predicting system comprising:
a measuring unit, measuring the actual demand of the plurality of load devices during a base period, wherein the base period comprises a first base period and a second base period;
a control unit, coupled to the measuring unit, calculating a predicted demand of the plurality of load devices during the second base period according to the actual demand of the plurality of load devices during the second base period, and determining whether the predicted demand of the plurality of load devices during the second base period is larger than a threshold;
a loading/unloading unit, coupled to the control unit, unloading at least one of the load devices when the predicted demand of the plurality of load devices during the second base period is larger than the threshold, so as to make the actual demand of the plurality of load devices during the second base period be less than a predetermined demand target, wherein the threshold is determined by the control unit according to a proportion of the demand target.

2. The power load monitoring and predicting system according to claim 1, further comprising:
a display unit, coupled to the control unit, for displaying the actual demand and the predicted demand;
an input unit, coupled to the control unit, for setting the demand target, wherein the threshold comprises a first threshold and a second threshold, and the first threshold is larger than the second threshold; and
an alarm unit, coupled to the control unit, for indicating an alarm signal on the display unit;
wherein the alarm unit indicates the alarm signal on the display unit when the control unit determines that the predicted demand of the plurality of load devices is larger than the first threshold during the second base period, and the loading/unloading unit sets the predicted demand to be the demand target and unloads at least one of the plurality of load devices.

3. The power load monitoring and predicting system according to claim 2, further comprising an environmental parameters monitoring unit coupled to the control unit for monitoring at least an environmental parameter corresponding to the plurality of load devices, the input unit being inputted with a different value;
wherein the loading/unloading unit unloads at least one of the plurality of load devices according to the environmental parameter when the control unit determines that the predicted demand of the plurality of load devices during the second base period is larger than the second threshold but less than the first threshold, thus the actual demand of the plurality of load devices is less than the predicted demand but larger than an expected demand of the plurality of load devices during the second base period, wherein the expected demand is the actual demand minus the difference value.

4. The power load monitoring and predicting system according to claim 2, wherein the loading/unloading unit loads at least one of the plurality of load devices according to the environmental parameter when the control determines that the predicted demand is less than the second threshold.

5. The power load monitoring and predicting system according to claim 3, wherein the loading/unloading unit loads at least one of the plurality of load devices according to the environmental parameter when the control determines that the predicted demand is less than the second threshold.

6. The power load monitoring and predicting system according to claim 1, wherein the predicted demand is estimated by a smart estimation scheme formed of the neural network, the fuzzy neural network, the genetic algorithm, the particle swarm optimization algorithm, or a combination thereof according to the actual demand.

7. The power load monitoring and predicting system according to claim 1, wherein the environmental parameters comprises at least one of the return water temperature of the central air conditioning, the room temperature, the room humidity and the concentration of carbon dioxide.

8. The power load monitoring and predicting system according to claim 1, wherein the threshold is determined according to a proportion of the predicted demand.

9. A power load monitoring and predicting method, for monitoring power load of a plurality of load devices, the power load monitoring and predicting method comprising:
measuring a first actual demand of the plurality of load devices during a first base period by a measuring unit;
calculating a first predicted demand of the plurality of load devices during a second base period by a control unit; and
unloading at least one of the plurality of load devices by a loading/unloading unit when the control unit determines that the first predicted demand is larger than a threshold, so as to make a second actual demand of the plurality of load devices be less than a predetermined demand target during the second base period, wherein the threshold is determined according to a proportion of the demand target.

10. The power load monitoring and predicting method according to claim 9, wherein the first threshold comprises a first threshold and a second threshold, and the first threshold is larger than the second threshold, the method further comprises:
displaying an alarm signal on a display unit by an alarm unit when the control unit determines that the first predicted demand is larger than the first threshold, and the loading/unloading unit setting the first predicted demand as the demand target and unloading at least one of the plurality of load devices.

11. The power load monitoring and predicting method according to claim 10, wherein the plurality of load devices are respectively corresponding at least an environmental parameter, an input unit is for setting a difference value, the method further comprises:
unloading at least one of the plurality of load devices by the loading/unloading unit according to the environmental parameter when the control unit determines that the first predicted demand is larger than a threshold but less than the first threshold, so as to make a second actual demand of the plurality of load devices be larger than an expected demand but less than a second predicted demand of the plurality of load devices during the second base period, wherein the expected demand is the second actual demand minus the difference value, and the second predicted demand is the load of the plurality of load devices during the second base period calculated by the control unit according to the first actual demand.

12. The power load monitoring and predicting method according to claim 11, wherein the loading/unloading unit loads at least one of the plurality of load devices according to the environmental parameter when the first predicted demand is less than the second threshold.

13. The power load monitoring and predicting method according to claim 9, wherein the predicted demand is estimated by a smart estimation scheme formed of the neural network, the fuzzy neural network, the genetic algorithm, the particle swarm optimization algorithm, or a combination thereof according to the first actual demand.

14. The power load monitoring and predicting method according to claim 9, wherein the environmental parameters comprises at least one of the return water temperature of the central air conditioning, the room temperature, the room humidity and the concentration of carbon dioxide.
